(19) United States
(12) Patent Application Publication
(10) Pub. No.: US 2019/0261790 A1
(43) Pub. Date: Aug. 29, 2019

(54) ARTICLES INCLUDING BENEFICIAL OBJECTS DISPERSED IN HORSEHAIR AND METHODS OF MANUFACTURE

(71) Applicant: DREAMZEN, INC., Las Vegas, NV (US)

(72) Inventors: DILIP KUMAR PATEL, IRVINE, CA (US); MANGESH MAHAJAN, IRVINE, CA (US)

(73) Assignee: DREAMZEN, INC., Las Vegas, NV (US)

(21) Appl. No.: 15/323,744

(22) PCT Filed: Jan. 3, 2017
(86) PCT No.: PCT/US17/12050

§ 371 Date: Jan. 4, 2017

(51) Int. Cl. A47G 9/00; A47C 27/22; A47C 27/15; B68G 1/00; D02G 3/00

(52) U.S. Cl. CPC A47G 9/007; A47C 27/22; A47G 2009/001; B68G 1/00; D02G 3/00; A47C 27/15

(57) ABSTRACT

The present disclosure provides an article and methods of its manufacture. The article may include a material configured to form an enclosure. The article may further include horsehair disposed within the enclosure. The article may also include a number of beneficial objects dispersed in the horsehair.

### TECHNICAL FIELD

The present disclosure generally relates to products for comforting a person while sleeping and resting. More particularly, the present disclosure relates to an article including horsehair and a number of beneficial objects dispersed in the horsehair, and methods of its manufacture. The article may be used in mattresses, pillows, bedding, cushions, blankets, and the like.

### BACKGROUND

Sleep products or products for comforting a person while sleeping and resting, such as mattresses, pillows, cushions, comforters, blankets, have already been proposed and known in the article. Usually, these sleep products include a cover encasing multiple layers of suitable filler material. The multiple layers may include a soft pliable core surrounded by one or more layers of synthetic foams, latex, birds' feathers, plastic, and so forth. The filler material may be encased in a cover of polyester, other synthetic and/or blended fabrics.

Sometimes, allergens and irritants such as dust mites, mold, dead skin, and bed bugs may build up on and/or within these multiple layers. In some instances, dead skin and pet dander may penetrate the sleep products, thereby providing food for dust mites. Many individuals are susceptible to certain kinds of allergies, especially from dust mites, and may develop allergic reactions, asthma, and skin irritation such as eczema.

Presently, there exists a pillow including an airflow device for selectively controlling airflow into and out of the pillow. The pillow may include a foam core surrounded by an inner layer of a non-breathable, non-woven fabric, a layer of soft material, and a cotton outer layer. Further, there exists a material composition for bedding, pillows, and mattresses that have multiple layers of silk, layers of horsehair or mixed layers of both silk and horsehair. Other conventional sleep products include layers of woven cotton fleece disposed between these layers.

The existing methods and products suffer from multiple drawbacks including lack of resiliency, toxicity of chemicals, flammable, reduced or no ventilation, very low moisture exchange, inducing allergic reactions, and so forth.

Hence, in light of the afore-mentioned, there remains a need for improved sleep and comforting products that, by virtue of its design and components, satisfies some of the needs that are known in the art and is thus an improvement over other related known sleep and comforting products.

### SUMMARY

An object of the present disclosure is to provide articles that may be manufactured by using natural horse hair between one or more layers of organic and natural fiber blends for sleep products. The sleep products may include such as pillows, comforters, blankets, mattresses, toppers used on top of the mattresses, upholstery in sofa, car seats, and so forth.

In some embodiments, an article may be provided. The article may include a material configured to form an enclosure. Further, the article may include horsehair disposed within the enclosure. Furthermore, the article may include a number of beneficial objects dispersed in the horsehair.

In some other embodiments, a method for manufacturing an article may be provided. The method may include forming a number of layers of horsehair. Further, the method may include dispersing a number of beneficial objects in the layers of horsehair. Furthermore, the method may include forming an enclosure of a material. The enclosure may include the layers of horsehair.

Further embodiments, features, and advantages, as well as the structure and operation of the various embodiments, are described in detail below with reference to the accompanying drawings.

### BRIEF DESCRIPTION OF DRAWINGS

Embodiments are described with reference to the accompanying drawings. In the drawings, like reference numbers can indicate identical or functionally similar elements.

FIG. 1A illustrates an exemplary article containing one or more beneficial objects dispersed in horsehair, in accordance with an embodiment of the present disclosure.

FIG. 1B illustrates a cross-sectional view showing internal configuration of the exemplary article of FIG. 1A, in accordance with an embodiment of the present disclosure.

FIG. 2A illustrates a cross-sectional view of an exemplary article including support structures having horsehair and beneficial objects, in accordance with an embodiment of the present disclosure.

FIG. 2B illustrates a cross-sectional view of an exemplary article having horsehair disposed in a substantial portion within an enclosure and in support structures, in accordance with an embodiment of the present disclosure.

FIG. 2C illustrates a support structure having a two-dimensional mesh, in accordance with an embodiment of the present disclosure.

FIG. 2D illustrates a support structure having a three-dimensional mesh, in accordance with an embodiment of the present disclosure.

FIG. 2E illustrates a support structure having one or more concentric layers, in accordance with an embodiment of the present disclosure.

FIG. 3 illustrates a cross-sectional view of an exemplary article having horsehair in a central portion, in accordance with some other embodiment of the present disclosure.

FIG. 4 illustrates a cross-sectional view of an exemplary article having horsehair disposed throughout an enclosure, in accordance with some other embodiment of the present disclosure.

FIG. 5 is a flowchart illustrating a method for manufacturing an article including beneficial objects dispersed in horsehair, in accordance with some embodiments of the present disclosure.

FIG. 6 illustrates an object using one or more exemplary articles including beneficial objects dispersed in horsehair.

FIG. 7 illustrates a bed including a mattress and a frame, in accordance with an embodiment of the present disclosure.

FIG. 8A illustrates a cross-sectional view of the bed of FIG. 7 in which the mattress includes horsehair and beneficial objects are dispersed in the horsehair, in accordance with an embodiment of the present disclosure.

FIG. 8B illustrates a cross-sectional view of the bed of FIG. 7 in which the mattress includes horsehair and beneficial objects dispersed in the horsehair and the frame includes horsehair, in accordance with an embodiment of the present disclosure.

FIG. 8C illustrates a cross-sectional view of the bed of FIG. 7 in which both the mattress and the frame include horsehair and beneficial objects dispersed in the horsehair, in accordance with an embodiment of the present disclosure.

### DETAILED DESCRIPTION

In the disclosure herein, consideration or use of a particular element number in a given FIG. or corresponding descriptive material can encompass the same, an equivalent, or an analogous element number identified in another FIG. or descriptive material corresponding thereto.

In the Detailed Description herein, references to “one embodiment”, “some embodiments”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic may be described in connection with some embodiments, it may be within the knowledge of one skilled in the art to effect such feature, structure, or characteristic in connection with other embodiments whether or not explicitly described.

The following detailed description refers to the accompanying drawings that illustrate exemplary embodiments. Some other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

### Overview

The present disclosure may provide articles that may be manufactured by using natural horse hair between one or more layers of organic and natural fiber blends for sleep products such as, pillows, comforters, blankets, mattresses, toppers used on top of the mattresses, sofa seats, and so forth. The articles may allow head and/or body of a user to rest and/or sleep. In the disclosed article, the horsehair may further include precious metals such as gold, silver, etc., gemstones, crystals, minerals, and combination thereof.

### Exemplary Embodiments

The present disclosure may relate to articles that may provide comfort to the users while sleeping and/or resting. The articles may be, for example, a pillow including a material forming an enclosure, horsehair disposed within the enclosure, and a number of beneficial objects dispersed in the horsehair.

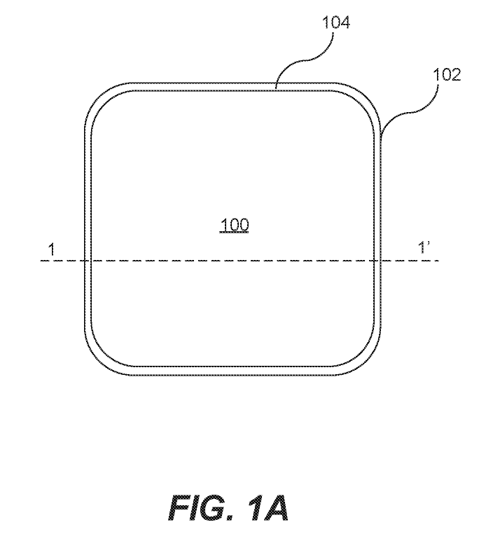

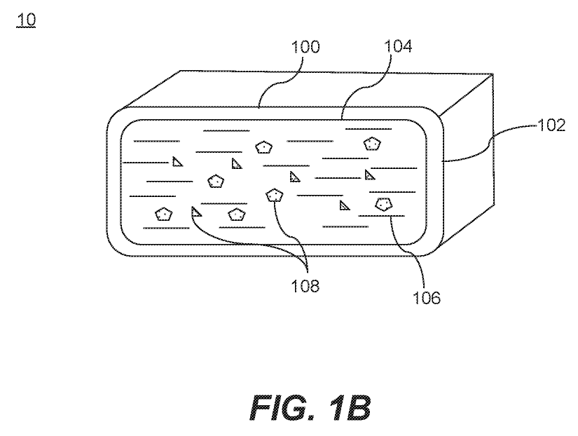

FIG. 1A illustrates an exemplary article 100 containing one or more beneficial objects dispersed in horsehair, in accordance with an embodiment of the present disclosure. As shown, the article 100 may include a material 102 configured to form an enclosure 104. In some embodiments, the article 100 may be a bedding article such as, but not limited to, one of a pillow, a mattress, a cushion, and a comforter. In some embodiments, the article 100 may be a furniture or part of the furniture, such as upholstery for sofa, car seat, and the material 102 may be a wood. In other embodiments the article 100 may be a furniture and the material 102 may be a metal.

The enclosure 104 may be formed by using the material 102 such as a fabric. The enclosure 104 may be formed by fastening a periphery of the fabric. The fastening may be a temporary fastening. Alternatively, the fastening may be a permanent fastening. The temporary fastening of the enclosure 104 may allow a user to access the internal components of the enclosure 104. Further, the temporary fastening may be done using fasteners such as, but not limited to, zippers, Velcro fasteners, buttons, and so forth. Further, the permanent fastening may be done using techniques, such as, but not limited to, sewing, gluing, and so forth.

In various embodiments, the enclosure 104 may be part of different types of objects such as a furniture like a chair, a sofa, a cot, a car seat, a mattress, a pillow, a comforter, a topper, a blanket, and so forth. For example, the enclosure 104 may be a back cushion in a chair. In some embodiments, the enclosure 104 may be made of the material 102, such as a fabric, on at least one side of the enclosure 104. For example, the article 100 may be a cushion of a chair, and the enclosure 104 may be a cushion cover, and one side such as a back of the cushion cover may be formed using a fabric.

Though the article 100 shown in the FIG. 1A is substantially rectangular, but a person skilled in the art will appreciate that the article 100 may be of any suitable size and shape such as circular, square, triangular, and so forth.

FIG. 1B illustrates a cross-sectional view 10 showing internal configuration of the article 100 across 1-1′, in accordance with an embodiment of the present disclosure. As shown, the article 100 may further include horsehair 106 disposed within the enclosure 104. The horsehair 106 may be a natural fiber made of stiff mane hairs and may be naturally springy and retains its shape well. In some embodiments, the horsehair 106 may be disposed within the enclosure 104 in the form of multiple layers. In some alternative embodiments, the horsehair 106 may be stuffed in the enclosure 104 such that the horsehair 106 may substantially occupy an entirety of the enclosure 104. The horsehair 106 may make the article 100 firm and springy. In some embodiments, the horsehair 106 may be disposed in the enclosure 104 in a single layer.

Further, the horsehair 106 may be filled in the article 100 for example in raw form or processed form. For example, the horsehair 106 may be available as balls, as loose strands, as layers, as yarn, and so forth. Moreover, the horsehair 106 may be filled substantially occupying an entirety of the enclosure 104. For example, yarns of the horsehair may be dispersed throughout the enclosure 104. In some embodiments, the horsehair 106 may be placed strategically at particular locations in the enclosure 104. For example, balls of the horsehair 106 may be placed at specific locations within the enclosure 104. In some embodiments, the horsehair 106 may be placed in a layered arrangement within the enclosure 104. For example, loose strands or layers of horsehair 106 may be disposed in a layered arrangement in the enclosure 104.

The article 100 may further include a number of beneficial objects 108 dispersed in the horsehair 106. In some embodiments, the beneficial objects 108 may be dispersed throughout the horsehair 106. In alternative embodiments, the beneficial objects 108 may be disposed between the adjacent layers of the horsehair 106. In some embodiments, the beneficial objects 108 may be distributed uniformly within the horsehair 106. Examples of the beneficial objects 108 may include, but are not limited, precious metals like gold, silver, platinum, etc., gemstones like emerald, sapphire, amethyst, diamond, ruby, etc., crystals, minerals, and so forth. In some other embodiments, the beneficial objects 108 may be distributed in the enclosure 104 based on a spatial configuration. For example, some specific type of the beneficial objects 108, for example stones, crystals, may be desirable to be proximal to a user therefore these beneficial objects 108 may be disposed on the peripheral regions within the enclosure 104 while other beneficial objects 108 such as, precious metals may be disposed in the central portion of the enclosure 104. The precious metals like gold and silver have antifungal and antibacterial properties, therefore, the gold and silver particles may be disposed around the peripheral regions within the enclosure 104.

In some embodiments, the beneficial objects 108 may be disposed between adjacent layers of the horsehair 106. Such embedding of the beneficial objects 108 may provide a natural way of securing the beneficial objects 108 between the layers of the horsehair 106. For example, the beneficial objects 108, like gemstones, may be embedded in a first layer then a second layer of the horsehair 106 may be disposed. After that, a third layer of the beneficial objects 108, like crystals, may be embedded in the layer of the horsehair 106, and a fourth layer of the horsehair 106 may be disposed over the third layer of the crystals. In alternative embodiments, the beneficial objects 108 may be dispersed evenly within a layer of the horsehair 106. Each pair of the adjacent beneficial objects 108 may have a uniform distance between them.

In some embodiments, each of the beneficial objects 108 may be situated within a cushioned envelope. In alternative embodiments, the positioning of the beneficial objects 108 may be such that in normal use, a user may not be inconvenienced by the presence of the beneficial objects 108. For example, the beneficial objects 108 may be embedded in a core or the central portion of the enclosure 104. In an exemplary scenario, the beneficial objects 108 may be located sufficiently deeply within the article 100 (for example, a cushion, a pillow, a mattress, etc.) so that even when a user bears weight on the article 100, the surrounding layers of the horsehair 106 may provide sufficient isolation.

In some other embodiments, the article 100 may be a bed and a base of the bed may include the enclosure 104. In such embodiments, the horsehair 106 may not contribute any springiness. However, the horsehair 106 may provide a support structure to the beneficial objects 108. In some embodiments, the beneficial objects 108 may be placed in the article 100 as well as in an object like a base of a bed, and the like, where the article 100 may be fixed. Further, this placement of the beneficial objects 108 in the article 100 and the object may result in more coherent effect for example, as similar to resonance, of the beneficial objects 108 to the user of the object. Examples of the object may include, but are not limited to, a bed, a chair, a sofa, a seat of the car, and so forth. In an exemplary scenario, the horsehair 104 may provide a homogenous surrounding that may be provided for the beneficial objects 108 in the article 100 like mattresses, and/or the beneficial objects 108 in a bed. The beneficial objects 108 in the mattress and the bed may result in more coherent effect of the beneficial objects 108 to the user of the bed.

In some embodiments, the beneficial objects 108 may be embedded as particles in the horsehair 106 or yarn formed using horsehair 106. Further, the beneficial objects 108 like minerals or crystals have natural oscillations that may be transferred in the form of electromagnetic waves to their environment such as a body of the user.

In an embodiment, the multiple layers of the horsehair 106 may be formed, and beneficial objects 108 may be dispersed in all of the multiple layers of the horsehair 106. After that, the enclosure 104 around the multiple layers of the horsehair 106 may be formed. In alternative embodiments, the enclosure 104 may be formed first and then multiple layers of the horsehair 106 including beneficial objects 108 may be disposed in the enclosure 104. In some embodiments, the beneficial objects 108 may be disposed only in one or alternative layers of the multiple layers of the horsehair 106.

The use of the horsehair 106 in the article 100 may ensure that a user of the article 100 may not exhibit allergic reactions or an excessive heating or perspiration in an area of the contact surface between the article 100 and body of the user.

The article 100 may be used by multiple users, such as a human or an animal, to enhance well-being, for example, a deeper sleep, restructure misaligned chakras, tranquilization, muscle relaxation, infusion of subtle healing energies, stress relieving, improved breathing, and so forth.

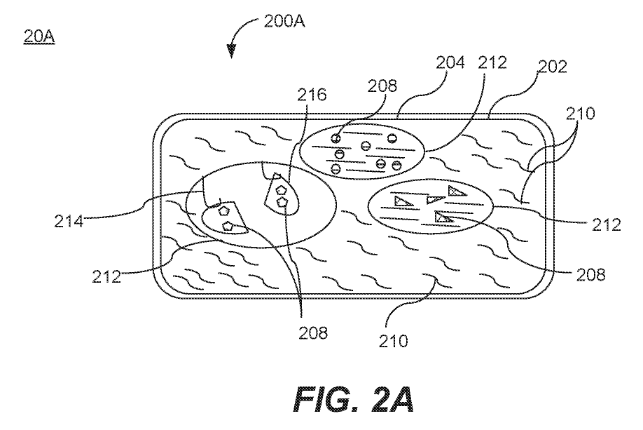

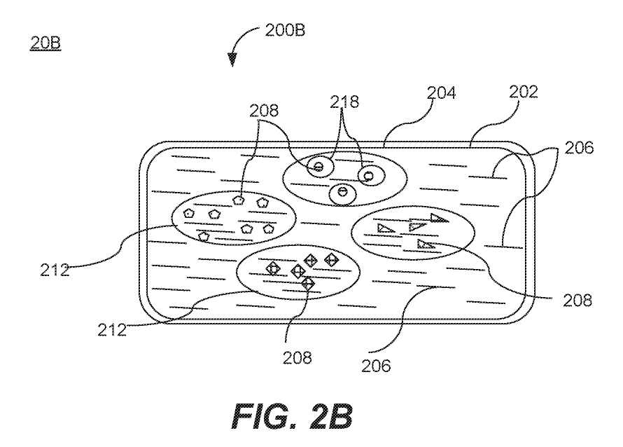

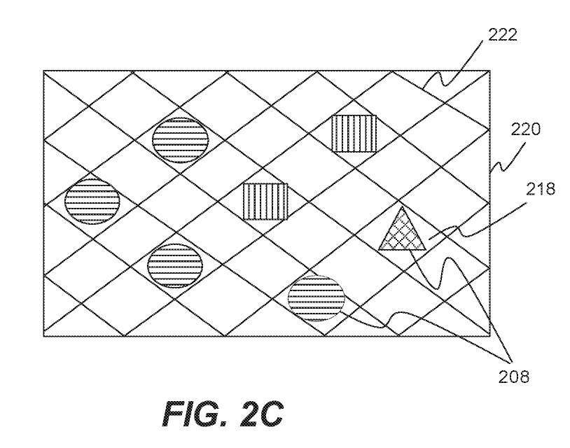

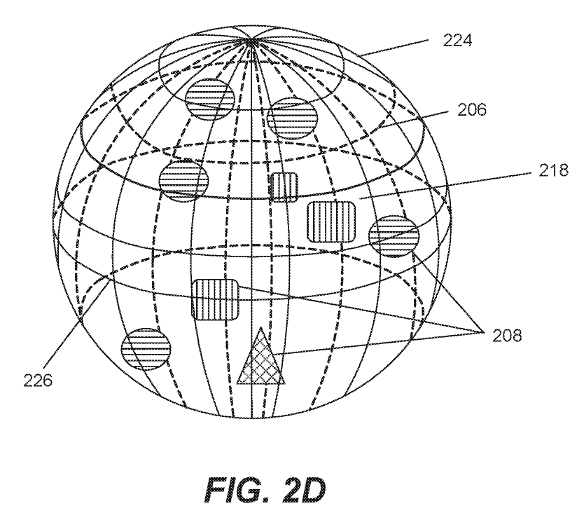

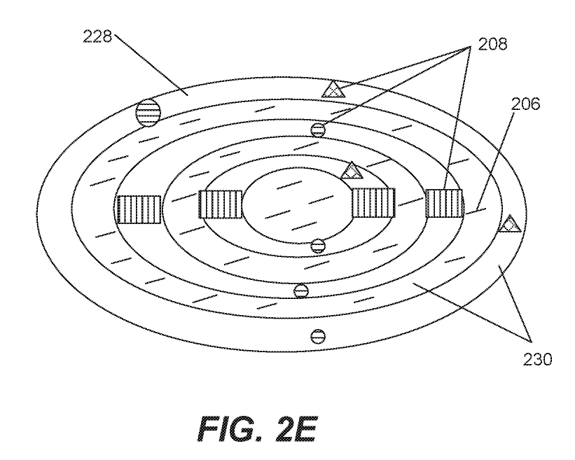

FIG. 2A illustrates a cross-sectional view 20A of an exemplary article 200A including support structures having horsehair and beneficial objects, in accordance with an embodiment of the present disclosure. As shown, the article 200A may include an enclosure 204 formed using a material 202. The material 202 may be, for example, but not limited to, a fabric. In some embodiments, the material 202 may be wood. In some alternative embodiments, the material 202 may be a metal such as, but not limited to, iron, steel, copper, aluminum, bronze, and so forth. Further, the article 200A may include a number of support structures 212 configured to secure a number of beneficial objects 208. Furthermore, the support structures 212 may be a two-dimensional mesh. Alternatively, each of the support structures 212 may include a three-dimensional mesh. Various embodiments of the support structures are described in detail with reference to subsequent FIGS. 2C-2D.

Further, the enclosure 204 may include other suitable materials 210 dispersed within. Examples of the other suitable materials 210 may include, but is not limited to, cotton, micro beads, hay, microfibers, latex, form, fabric, birds' feathers, natural shredded rubber, wood, synthetic fibers, cereal grains like wheat, pulses, mustard seeds, rice, fruit seeds like cherry pits, dried herbs, grasses, and combination of these. In some embodiments, the support structures 212 may be uniformly placed within the other suitable materials 210 in the enclosure 204. In some alternative embodiments, the support structures 212 may be placed within the other suitable materials 210 in the enclosure 204 based on a spatial configuration

In some embodiments, each of the support structures 212 may include horsehair yarn. In some embodiments, the support structures 212 may be made up of horsehair that may be stronger and stiffer than horsehair 206 and may also include the horsehair 206. In some alternative embodiments, the support structures 212 may be made up of other material like fabric, cotton, foam, sponge, wood, and so forth and may include the horsehair 206. In some embodiments, the support structures 212 may include the beneficial objects 208 dispersed in the horsehair 206. In some embodiments, the beneficial objects 208 may be secured according to a spatial configuration.

In some embodiments, the support structures 212 may include a number of concentric layers described in detail with reference to subsequent FIG. 2E. In some embodiments, the support structures 212 may include a number of loops 214 configured to receive one or more hooks attached to at least one pouch 216 holding one or more of the beneficial objects 208. In some embodiments, the pouch 216 may be attached to the loops 214 directly.

FIG. 2B illustrates a cross-sectional view 20B of an exemplary article 200B having the horsehair 206 disposed in a substantial portion of the enclosure 204 and in the support structures 212, in accordance with an embodiment of the present disclosure. As shown, the article 200B may include the enclosure 204 that may further include the support structures 212 having the horsehair 206. The horsehair 206 may be dispersed such that the horsehair 206 substantially occupies an entirety in the enclosure 204 and surrounds the support structures 212. In such embodiments, the support structures 212 may be formed using fabric, etc. In some other embodiments, the support structures 212 may be formed using horsehair yarn.

In some embodiments, the support structures 212 may include a number of cavities 218. In some other embodiments, the cavities 218 may be formed by the layers of the horsehair 206 according to a spatial configuration. Each of the cavities 218 may be configured to accommodate at least one of the beneficial objects 208. The cavities 218 may secure the beneficial objects 208 in a particular place in the support structures 212. Though the cavities 218 are shown to be circular in shape, the cavities 218 may be formed in any shape. In some embodiments, a shape and size of the cavities 218 may be in accordance with a shape and size of the beneficial objects 208.

In some embodiments, the enclosure 204 may include the cavities 218 for securing one or more of the beneficial objects 208 in a particular place within the enclosure 204.

FIG. 2C illustrates a support structure 220 having a two-dimensional mesh 222, in accordance with an embodiment of the present disclosure. The two-dimensional mesh 222 may be formed using multiple strands of the horsehair 206. The cavities 218 may be formed by a crisscross arrangement of the horsehair 206 in the two-dimensional mesh 222. In some embodiments, the cavities 212 may be formed by a layered arrangement of the horsehair 206 in the two-dimensional mesh 222. Each of the cavities 218 may be configured to accommodate at least one of the beneficial objects 208. The cavities 218 may secure the beneficial objects 208 in a particular place in the support structure 220. Though the support structure 220 is shown as of rectangular shape, a person skilled in the art will appreciate that the support structure 220 may be of any shape such as circular, square, triangle, and so forth.

FIG. 2D illustrates a support structure 224 having a three-dimensional mesh 226, in accordance with an embodiment of the present disclosure. The three-dimensional mesh 226 may be formed using horsehair yarn, horsehair balls, and/or loose horsehair 206. Further, the cavities 218 may get formed within the three-dimensional mesh 226. The three-dimensional mesh 226 may be formed by arranging the horsehair 206 (other suitable materials such as cotton, fabric, microfibers, latex, and so forth) into multiple layers. In some embodiments, the three-dimensional mesh 226 may be formed by dispersing the horsehair 206. The beneficial objects 208 may be disposed in the cavities 218. Though the support structure 224 is shown as of spherical shape, a person skilled in the art will appreciate that the support structure 224 may be of any suitable shape such as cuboidal, cubical, and so forth.

FIG. 2E illustrates a support structure 228 having one or more concentric layers 230, in accordance with an embodiment of the present disclosure. Each of the concentric layers 230 may be configured to support at least one of the beneficial objects 208. In some embodiments, the concentric layers 230 may be located at a uniform distance from each other. In alternative embodiments, the distance between two or more of the concentric layers may not be uniform and may vary.

In some embodiments, the one or more concentric layers 230 may be formed using the horsehair 206. Further, the beneficial objects 208 may be placed within each or some of the concentric layers 230 to provide one or more healing and stimulating benefits to a user of the article 200A (or the article 200B). For example, beneficial objects 208 may be placed in a first concentric layer, horsehair 206 may be disposed to form a second concentric layer, and similarly further layers may be formed. In some embodiments, the beneficial objects 208 may be placed between the empty spaces formed between at least two adjacent concentric layers 230 of the horsehair 206.

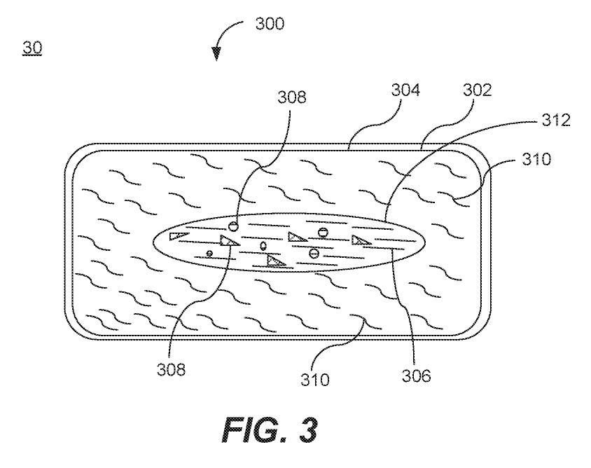

FIG. 3 illustrates a cross-sectional view 30 of an exemplary article 300 having horsehair 306 in a central portion 312, in accordance with some other embodiment of the present disclosure. As shown, the article 300 may include a material 302 configured to form an enclosure 304. In some embodiments, the material 302 may be fabric. In some other embodiments, the material 302 may be wood. In some alternative embodiments, the material 302 may be a metal.

The article 300 may further include the horsehair 306 disposed within the central portion 312 of the enclosure 304 forming a core of the article 300. In some embodiments, the horsehair 306 may be filled in a cover and then may be placed in the central portion 312 of the enclosure 304. The cover may be formed using a suitable material such as, but not limited to, fabric, latex, and so forth. The central portion 312 may also include one or more beneficial objects 308 dispersed in the horsehair 306. Examples of the beneficial objects 308 may include, but are not limited to, precious metals like gold, silver, platinum, etc., gemstones like ruby, emerald, tanzanite, sapphire, topaz, etc., crystals, minerals, and so forth. The beneficial objects 308 may be uniformly placed in the horsehair 306. In some embodiments, one or more layers of the horsehair 306 may form one or more cavities (refer 218 in FIG. 2B), in which the one or more of the beneficial objects 308 may be placed. The placement of the beneficial objects 308 in the horsehair 306 may vary depending on a requirement of an effect such as healing effect, relaxing effect, and so forth, desired by a user.

In some embodiments, the beneficial objects 308 may be filled in a pouch (not shown) and may be placed in the horsehair 306. The pouch may be formed using a suitable material such as, but not limited to, synthetic fiber, fabric, cotton, foam, latex, and so forth. In an exemplary scenario, the beneficial objects 308 may be located sufficiently deeply within the article 300 (for example, a cushion, a pillow, a mattress, etc.) so that even when a user bears weight on the article 300, the surrounding layers of horsehair 306 and/or other suitable materials 310 may provide sufficient isolation.

The enclosure 304 may include other suitable materials 310 disposed around the central portion 312. Examples of the other suitable materials 310 may include, but are not limited to, cotton, micro beads, hay, microfibers, latex, form, fabric, birds' feathers, natural shredded rubber, wood, synthetic fibers, cereal grains like wheat, pulses, mustard seeds, rice, fruit seeds like cherry pits, dried herbs, grasses, and combination of these.

In some embodiments, the enclosure 304 may be formed around the other suitable materials 310 after arranging the horsehair 306 including the dispersed beneficial objects 308 in the core, and the other suitable materials 310 around the core of the horsehair 306.

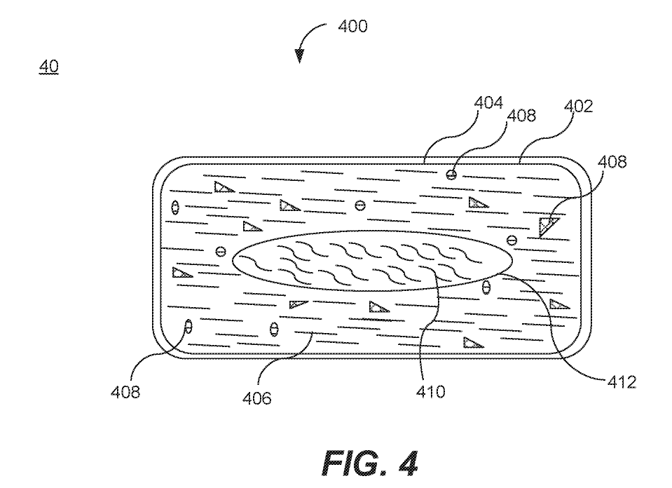

FIG. 4 illustrates a cross-sectional view 40 of an exemplary article 400 having horsehair 406 disposed throughout an enclosure 404, in accordance with some other embodiment of the present disclosure. As shown, the article 400 may include a material 402 configured to form the enclosure 404. In some embodiments, the material 402 may be a fabric.

The article 400 may further include other suitable materials 410 disposed in a central portion 412 of the enclosure 404 to form a core of the article 400. In some embodiments, the other suitable materials 410 may be disposed in multiple layers. Examples of the other suitable materials 410 may include, but are not limited to, cotton, micro beads, hay, microfibers, latex, form, fabric, birds' feathers, natural shredded rubber, wood, synthetic fibers, cereal grains like wheat, pulses, mustard seeds, rice, fruit seeds like cherry pits, dried herbs, grasses, and combination of these. In some embodiments, the other suitable materials 410 may be filled in a cover (not shown) and the cover may be placed in the central portion 412 of the enclosure 404. The cover may be formed using a suitable material such as, but not limited to, synthetic fiber, fabric, cotton, form, and so forth.

Further, the enclosure 404 may include the horsehair 406 disposed around the layers of the other suitable materials 410. The horsehair 406 may further include one or more beneficial objects 408 dispersed in the horsehair 406. Examples of the beneficial objects 408 may include, but are not limited to, precious metals like gold, silver, platinum, etc., gemstones like ruby, emerald, tanzanite, sapphire, topaz, etc., crystals, minerals, and so forth. The beneficial objects 408 may be uniformly placed in the horsehair 406. In some embodiments, the horsehair 406 may form one or more cavities, in which the one or more of the beneficial objects 408 may be placed. However, the placement of the beneficial objects 408 in the horsehair 406 may vary depending on an effect or benefit requirement of a user.

The article 400 having an outer layer of the horsehair 106 may make a dry pillow texture and may be good for users who sweat while they sleep as the horsehair 106 are good moisture absorbent.

In some embodiments, the enclosure 404 may be formed around the horsehair 406 after arranging the other suitable materials 410 in the core, and the horsehair 406 including the dispersed beneficial objects 408 around the core of the other suitable materials.

### Exemplary Method Flowchart—Manufacturing an Article Including Beneficial Objects Dispersed in Horsehair

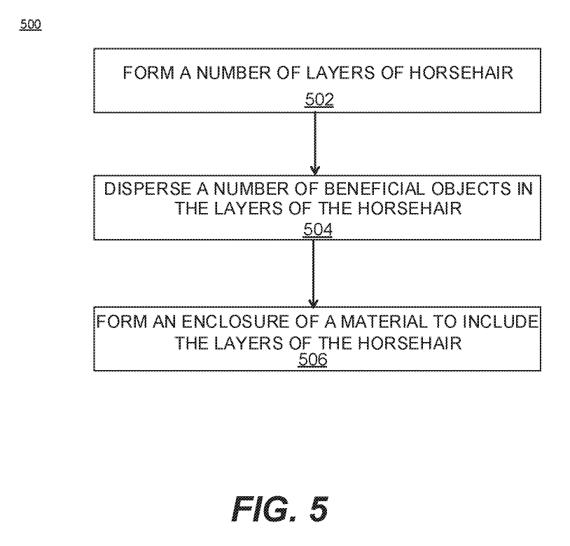

FIG. 5 is a flowchart illustrating a method 500 for manufacturing an article including beneficial objects dispersed in horsehair, in accordance with some embodiments of the present disclosure. While discussing the method 500, references to other figures will be made.

At step 502, multiple layers of horsehair may be formed. The multiple layers of the horsehair may be formed from the horsehair in its raw form and/or horsehair yarn. The horsehair may provide springiness and firmness to the article.

Then at step 504, a number of beneficial objects may be dispersed in the multiple layers of the horsehair. The beneficial objects may include, but are not limited to, gemstones, crystals, precious metals, and crystals. The beneficial objects may be dispersed uniformly in the multiple layers of the horsehair. Alternatively, the beneficial objects may be dispersed in a spatial arrangement. In some embodiments, the beneficial objects may be fixed in one or more cavities formed in the multiple layers of the horsehair. In alternative embodiments, the beneficial objects may be filled in one or more pouches, and these pouches may be placed in the multiple layers of the horsehair. The beneficial objects may be dispersed in between adjacent layers of the multiple layers of the horsehair. In some embodiments, the beneficial objects may be dispersed in at least one layer of the multiple layers of the horsehair.

After that, at step 506, an enclosure may be formed using a material to include the multiple layers of the horsehair. The enclosure may be closed from one or more peripheries of the enclosure by using temporary fastening. Alternatively, the one or more peripheries of the enclosure may be closed by using permanent fastening.

### Exemplary Use Case and Scenario

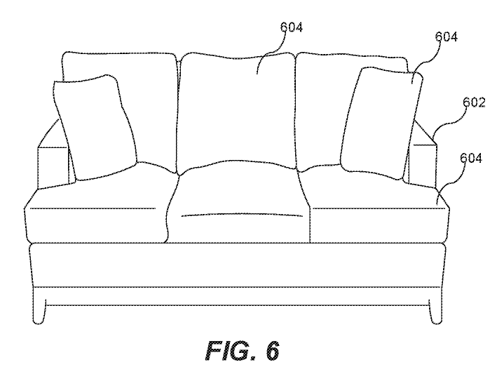

FIG. 6 illustrates an object such as a sofa 602 using one or more exemplary articles 604 including beneficial objects dispersed in horsehair. As shown, the sofa 602 may include one or more articles 604 fixed on the sofa 602. The articles 604 may be used as a sofa backrest, a sofa cushion, a sofa seat, and other upholstery of the sofa 602 so forth. Each of the articles 604 may include the beneficial objects dispersed in the horsehair (such as the beneficial objects 108 dispersed in the horsehair 106 as discussed with reference to FIGS. 1A-1B).

Further, the configuration of the internal components of the articles 604 may vary depending on benefits needed for a user of the sofa 602. For example, the horsehair may be disposed in multiple layers within an enclosure (such as the enclosure 104) and beneficial objects may be dispersed in each of the multiple layers of horsehair. In another example, the horsehair may be disposed in multiple covers and may be placed uniformly within the enclosure. And in each of the multiple covers of horsehair, one or more beneficial objects may be dispersed. Further, in some embodiments, each of the multiple covers may include a specific type of the beneficial objects. For example, some of the multiple covers may include precious metals like gold, silver, etc. some other of the multiple covers may include precious gemstones like diamond, rubies, etc. and yet some other of the multiple covers may include minerals. In alternative embodiments, each of the multiple covers may have a mix of beneficial objects. For example, each of the multiple covers may have minerals, crystals, metals, gemstones, and so forth. Further, the beneficial objects may be dispersed in their raw form in the horsehair or may be dispersed in the processed form. For example, one or more princess cut diamond may be dispersed in the horsehair.

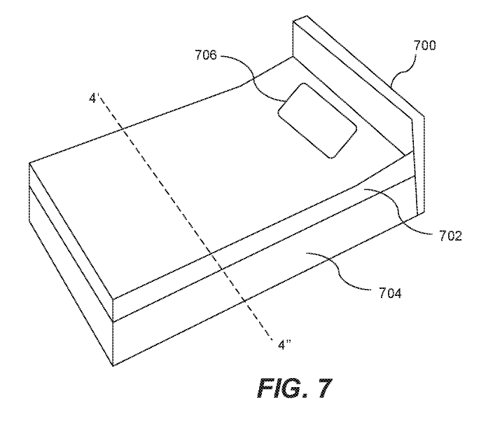

FIG. 7 illustrates an exemplary bed 700 including a mattress 702 and a base 704, in accordance with an embodiment of the present disclosure. The mattress 702 may be an article including an enclosure including horsehair, beneficial objects dispersed in the horsehair, and other articles such as fabric, cotton, latex, and so forth. The base 704 may provide a foundation to the bed 700.

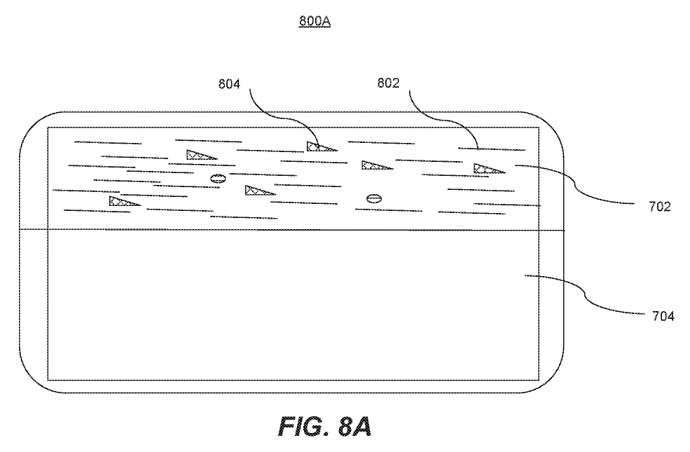

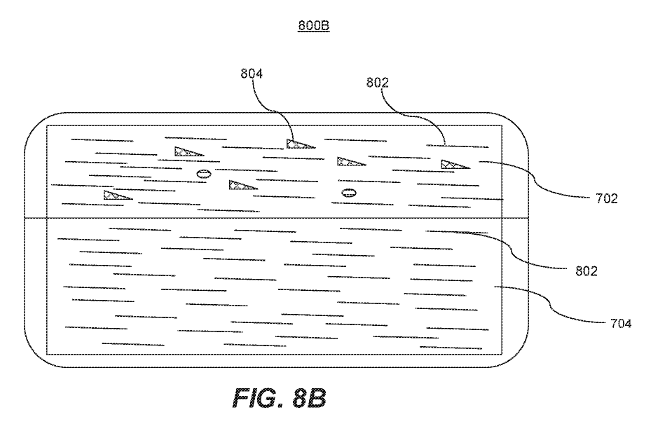

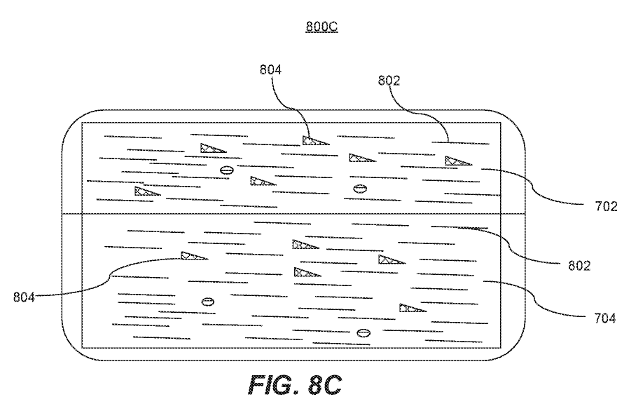

FIG. 8A illustrates a cross-sectional view 800A of a bed such as the bed 700 along a line 4′-4″, in accordance with an embodiment of the present disclosure. The bed 700 may include the mattress 702 and the base 704. The mattress 702 may include horsehair 802 and a number of beneficial objects 804 dispersed in the horsehair 802. The beneficial objects 804 may include, but are not limited to, gemstones, crystals, precious metals, and crystals.

In some embodiments, the beneficial objects 804 may be dispersed uniformly in the multiple layers of the horsehair. Alternatively, the beneficial objects 804 may be dispersed in a spatial arrangement. Further, in some embodiments, the beneficial objects 804 may be fixed in one or more cavities formed in the multiple layers of the horsehair 802. In alternative embodiments, the beneficial objects 804 may be filled in one or more pouches, and these pouches may be placed in the multiple layers of the horsehair 802.

Further, the beneficial objects 804 may be dispersed in between adjacent layers of the multiple layers of the horsehair 802. Alternatively and/or additionally, in some embodiments, the beneficial objects 804 may be dispersed in at least one layer of the multiple layers of the horsehair 802.

FIG. 8B illustrates a cross-sectional view 800B of a bed such as the bed 700, in accordance with an embodiment of the present disclosure. As shown, the bed 700 may include the mattress 702 and the horsehair 802. The mattress 702 may in turn further include the horsehair 802 and the beneficial objects 804 dispersed in the horsehair 802. Further, the base 704 may include the horsehair 802. The horsehair 802 in the mattress 702 and in the base 704 may provide superior resiliency and springiness.

FIG. 8C illustrates a cross-sectional view 800C of a bed such as the bed 700, in accordance with an embodiment of the present disclosure. As shown, the bed 700 may include the mattress 702 and the horsehair 802. The mattress 702 may further include the horsehair 802 and the beneficial objects 804 dispersed in the horsehair 802. Further, the base 704 may include the horsehair 802 and the beneficial objects 804 dispersed in the horsehair 802. The horsehair 802 in the mattress 702 and the base 704 may provide superior ventilation and breathability.

Further, the beneficial objects 804 like precious gemstones, metals, crystals, minerals, etc. in the mattress 702 and the base 704 may help in increasing vibrational and infusion of subtle healing energies in a user of the bed 700. Further, the beneficial objects 804 may stimulate awareness in the user. Furthermore, the beneficial objects 804 may restructure misaligned chakras, meridians and body systems of the user. Furthermore, the beneficial objects 804 may exert calming influence and may release the stress of the user.

The disclosed article may have superior resiliency and springiness. Further, the disclosed article may be free from any toxicity as there may be no harmful chemicals in the articles. Furthermore, the disclosed article may provide superior ventilation and breathability.

Further, the disclosed article may be naturally non-allergic. Furthermore, the disclosed article may provide superior moisture exchange and absorbency. For example, a pillow formed using disclosed methods may ensure superior moisture exchange and absorbency.

The disclosed article having an outer layer of the horsehair may make a dry pillow texture and may be good for users who sweat while they sleep as the horsehair are good moisture absorbent.

The use of beneficial objects like precious gemstones, metals, crystals, minerals, etc. may help in increasing vibrational and infusion of subtle healing energies in a user of the article. Further, the beneficial objects may stimulate awareness in the user. Furthermore, the beneficial objects may restructure misaligned chakras, meridians and body systems of the user. Furthermore, the beneficial objects may exert calming influence and may release the stress of the user.

Further, the article including the horsehair and the beneficial objects may be used by multiple users, such as a human or an animal, to enhance well-being, for example, a deeper sleep, as tranquilizers, for muscle relaxation, relief of breathing, and so forth.

Further, the use of beneficial objects like precious metals gold, silver in the article may have antibacterial and antifungal properties. The disclosed article may also provide protection to the user from undesirable electromagnetic frequencies and electromagnetic smog.

The brief Summary and Abstract sections may set forth one or more, but not all example embodiments and thus are not intended to limit the scope of the present disclosure and appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The preceding description of specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described example embodiments, but should be defined only in accordance with the following claims and their equivalents.

1. An article comprising:
a. a material configured to form an enclosure;
b. horsehair disposed within the enclosure; and
c. a plurality of beneficial objects dispersed in the horsehair.

2. The article of claim 1, wherein the horsehair is disposed in the enclosure in a plurality of layers.

3. The article of claim 1 being a bedding article, wherein the material comprises a fabric.

4. The article of claim 3, wherein the bedding article is at least one of a pillow, a mattress and a comforter.

5. The article of claim 1 being a bed, wherein a base of the bed comprises the enclosure.

6. The article of claim 1 being a furniture, wherein the material comprises at least one of wood and metal.

7. The article of claim 1, wherein the plurality of beneficial objects comprises at least one of a precious metal, a crystal, a gemstone and a mineral.

8. The article of claim 1, wherein the horsehair substantially occupies an entirety of the enclosure.

9. The article of claim 1, wherein the plurality of beneficial objects are dispersed throughout the horsehair.

10. The article of claim 2, wherein the plurality of beneficial objects are disposed between adjacent layers of horsehair.

11. A method of manufacturing an article, the method comprising:
a. forming a plurality of layers of horsehair;
b. dispersing a plurality of beneficial objects in the plurality of layers of horsehair; and
c. forming an enclosure of a material, wherein the enclosure comprises the plurality of layers of horsehair.

12. The method of claim 11, wherein dispersing the plurality of beneficial objects is performed in between adjacent layers of the plurality of layers of horsehair.

13. The method of claim 11, wherein dispersing the plurality of beneficial objects is performed within at least one layer of the plurality of layers of horsehair.

14. The method of claim 11, wherein the article is a bedding article, wherein the material comprises at least one fabric, wherein forming of the enclosure comprises fastening a periphery of at least one fabric.

15. The method of claim 14, wherein the fastening is at least one of a temporary fastening and a permanent fastening.

16. The method of claim 11, wherein the plurality of beneficial objects comprises at least one of a precious metal, a crystal, a gemstone and a mineral.

17. The method of claim 11, wherein dispersing of the plurality of beneficial objects is performed according to a spatial configuration.

18. The method of claim 17 further comprising forming a plurality of cavities in the plurality of layers of horsehair according to the spatial configuration, wherein a cavity is configured to accommodate at least one of the plurality of beneficial objects.

19. The method of claim 17 further comprising:
a. forming a support structure configured to secure the plurality of beneficial objects; and
b. securing the plurality of beneficial objects according to the spatial configuration, wherein dispersing the plurality of beneficial objects in the horsehair comprises placing each of the support structure and the plurality of layers of horsehair within the enclosure.

20. The method of claim 19, wherein the support structure comprises horsehair yarn.

21. The method of claim 19, wherein the support structure is at least one of a two dimensional mesh and a three-dimensional mesh.

22. The method of claim 21, wherein the support structure comprises a plurality of concentric layers, wherein each concentric layer is configured to support a plurality of beneficial objects.
